(19) United States
(12) Patent Application Publication
(10) Pub. No.: US 2021/0182910 A1
(43) Pub. Date: Jun. 17, 2021

(54) CONTROL DEVICE, SYSTEM, NON-TRANSITORY STORAGE MEDIUM, AND CONTROL METHOD

(71) Applicants: Toyota Jidosha Kabushiki Kaisha, Toyota-shi (JP); Nomura Research Institute, Ltd., Tokyo (JP)

(72) Inventors: Daiki Kaneichi, Nisshin-shi (JP); Naoya Sugita, Tokyo (JP)

(73) Assignees: Toyota Jidosha Kabushiki Kaisha, Toyota-shi Aichi-ken (JP); Nomura Research Institute, Ltd., Tokyo (JP)

(21) Appl. No.: 17/116,404

(22) Filed: Dec. 9, 2020

(30) Foreign Application Priority Data
Dec. 12, 2019 (JP) 2019-224944

(51) Int. Cl. G06Q 30/02; G01C 21/34

(52) U.S. Cl. CPC G06Q 30/0266; G01C 21/3453; G01C 21/3415; G06Q 30/0267

(57) ABSTRACT

A control device includes a controller. The controller is configured to determine, when advertisement information received via a first device is selected by a user riding in a vehicle, a second route via a point associated with the advertisement information as a route that is newly set in a second device. The second device is a device that is used for navigation in the vehicle, and the second route is a route to a destination that is the same as a destination of a first route set in the second device.

### CROSS-REFERENCE TO RELATED APPLICATIONS

This application claims priority to Japanese Patent Application No. 2019-224944 filed on Dec. 12, 2019, which is incorporated herein by reference in its entirety including the specification, drawings and abstract.

### BACKGROUND

### 1. Technical Field

The present disclosure relates to control devices, systems, non-transitory storage media, and control methods.

### 2. Description of Related Art

Japanese Unexamined Patent Application Publication No. 2002-342426 (JP 2002-342426 A) describes a technique that improves efficiency in dispatching a taxi etc. via communication means.

Japanese Unexamined Patent Application Publication No. 2019-8769 (JP 2019-8769 A) describes a technique of acquiring desired pickup or drop-off location information of a plurality of users who share a ride, determining a plurality of routes based on the desired pickup or drop-off location information, and applying a gain or cost to the users depending on which route is selected by each user.

### SUMMARY

Neither of the techniques described in JP 2002-342426 A and JP 2019-8769 A discloses guiding a user to a point associated with an advertisement.

The present disclosure provides a technique of guiding a user to a point associated with an advertisement.

A first aspect of the present disclosure is a control device. The control device includes a controller. The controller is configured to determine, when advertisement information received via a first device is selected by a user riding in a vehicle, a second route via a point associated with the advertisement information as a route that is newly set in a second device. The second device is a device that is used for navigation in the vehicle, and the second route is a route to a destination that is the same as a destination of a first route set in the second device.

In the first aspect, the advertisement information may include an identifier of at least one point, and the controller may be configured to specify a point corresponding to the identifier included in the advertisement information as the point associated with the advertisement information.

In the first aspect, the advertisement information may include an identifier of at least one facility, and the controller may be configured to specify a point where the facility corresponding to the identifier included in the advertisement information is located as the point associated with the advertisement information.

In the first aspect, the advertisement information may include an identifier of at least one product, and the controller may be configured to specify a point where the product corresponding to the identifier included in the advertisement information is sold as the point associated with the advertisement information.

In the first aspect, the controller may be configured to notify, before determining the second route as the route that is newly set in the second device, the user of first travel time and second travel time, or a difference between the first travel time and the second travel time. The first travel time is required to reach the destination for the first route. The second travel time is required to reach the destination for the second route.

In the first aspect, the controller may be configured to notify, before determining the second route as the route that is newly set in the second device, the user of first travel cost and second travel cost, or a difference between the first travel cost and the second travel cost. The first travel cost is required to reach the destination for the first route. The second travel cost is required to reach the destination for the second route.

In the first aspect, the control device may be configured to also function as the first device.

In the first aspect, the control device may further include a transmitter configured to communicate with the first device, and the controller may be configured to distribute the advertisement information to the first device via the transmitter.

In the first aspect, the transmitter may be configured to communicate with a third device that is used in at least one facility, and the controller may be configured to receive the advertisement information from the third device via the transmitter and may be configured to distribute the received advertisement information to the first device.

In the first aspect, the control device may be configured to also function as the second device.

In the first aspect, the control device may further include a transmitter configured to communicate with the second device, and the controller may be configured to set the determined second route in the second device via the transmitter.

In the first aspect, the transmitter may be configured to communicate with a third device that is used in at least one facility, and the controller may be configured to receive the advertisement information from the third device via the transmitter.

In the first aspect, the advertisement information may be distributed to the first device via a wireless LAN in the vehicle.

A second aspect of the present disclosure is a system including a control device and a first device. The control device includes a controller. The controller is configured to determine, when advertisement information received via the first device is selected by a user riding in a vehicle, a second route via a point associated with the advertisement information as a route that is newly set in a second device. The second device is a device that is used for navigation in the vehicle, and the second route is a route to a destination that is the same as a destination of a first route set in the second device.

In the second aspect, the system may further include the second device.

A third aspect of the present disclosure is a non-transitory storage medium storing instructions that are executable by one or more processors and that cause the one or more processors to perform functions. The function includes: causing advertisement information received via a first device to be selected by a user riding in a vehicle; and determining a second route via a point associated with the advertisement information as a route that is newly set in a second device. The second device is a device that is used for navigation in the vehicle, and the second route is a route to a destination that is the same as a destination of a first route set in the second device.

In the third aspect, the one or more processors may be included in a control device and the first device.

In the third aspect, the one or more processors may be included in a control device and the second device.

In the third aspect, the advertisement information may be distributed to the first device via a wireless LAN in the vehicle.

A fourth aspect of the present disclosure is a control method. The control method includes: causing advertisement information received via a first device to be selected by a user riding in a vehicle; and determining a second route via a point associated with the advertisement information as a route that is newly set in a second device, the second device being a device that is used for navigation in the vehicle, and the second route being a route to a destination that is the same as a destination of a first route set in the second device.

According to the first, second, third, and fourth aspects of the present disclosure, the user can be guided to the point associated with the advertisement.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 illustrates the configuration of a system according to an embodiment;

FIG. 2 is a block diagram illustrating the configuration of a control device according to the embodiment;

FIG. 3 is a block diagram illustrating the configuration of a first device according to the embodiment;

FIG. 4 is a block diagram illustrating the configuration of a second device according to the embodiment;

FIG. 5 illustrates the operation of a system according to the embodiment; and

FIG. 6 illustrates an example of a screen of a terminal according to the embodiment.

### DETAILED DESCRIPTION OF EMBODIMENTS

An embodiment will be described with reference to the accompanying drawings.

The same or corresponding portions are denoted with the same signs throughout the drawings. In the description of the embodiment, description of the same or corresponding portions will be omitted or simplified as appropriate.

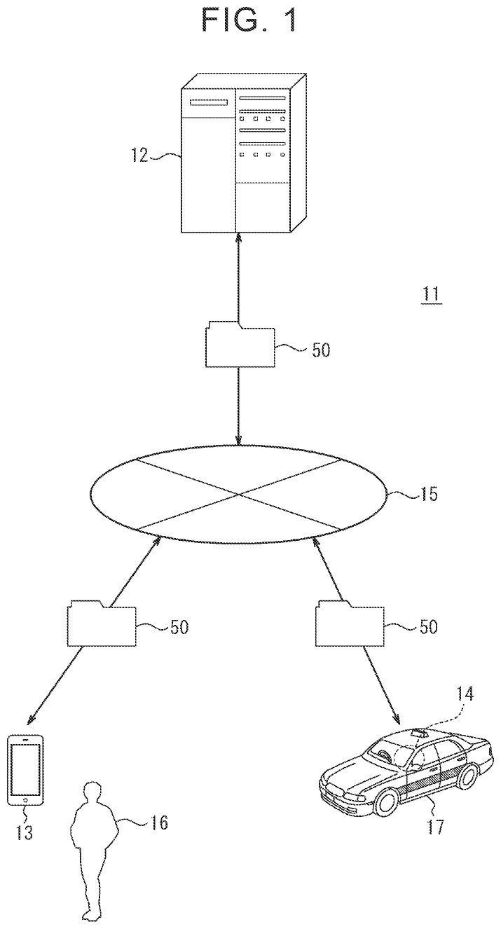

The configuration of a system 11 according to the present embodiment will be described with reference to FIG. 1.

The system 11 according to the present embodiment includes at least one server 12, at least one terminal 13, and at least one device 14.

The terminal 13 can communicate with the server 12 via a network 15 such as a wireless LAN, a mobile network, and the Internet. The terminal 13 may be able to communicate with the device 14 via the network 15. “LAN” stands for local area network.

The server 12 can communicate not only with the terminal 13 but also with the device 14 via the network 15.

The device 14 is connected wired or wireless to a vehicle 17 or is built-in to the vehicle 17.

In the present embodiment, the vehicle 17 is a taxi. However, the vehicle 17 may be an automobile other than a taxi, such as an on-demand bus, as long as it can transport a user 16. The vehicle 17 is any type of automobile such as a gasoline vehicle, a diesel vehicle, an HV, a PHV, an EV, or an FCV. “HV” stands for hybrid vehicle. “PHV” stands for plug-in hybrid vehicle. “EV” stands for electric vehicle. “FCV” stands for fuel cell vehicle. In the present embodiment, the vehicle 17 is driven by a driver. However, driving of the vehicle 17 may be automated at a desired level. For example, the level of driving automation is one of levels 1 to 5 defined by SAE. “SAE” stands for the Society of Automotive Engineers. The vehicle 17 may be a MaaS-dedicated vehicle. “MaaS” stands for Mobility as a Service.

An overview of the present embodiment will be provided with reference to FIGS. 1, 2, 3, and 4.

In the system 11 shown in FIG. 1, when the user 16 riding in the vehicle 17 receives advertisement information 50 via a first device 30 configured as the terminal 13 and selects the advertisement information 50, a control device 20 configured as the server 12 determines a second route as a route that is newly set in a second device 40 configured as the device 14. The second device 40 is a device that is used for navigation in the vehicle 17, and the second route is a route to the same destination as that of a first route set in the second device 40 but via a point associated with the advertisement information 50.

The “advertisement information 50” refers to, for example, text, a still image, or a video that is delivered (distributed) to advertise at least one point, at least one facility, or at least one product. The advertisement information 50 may include an “identifier” that specifies at least one point, at least one facility, or at least one product.

The expression “select the advertisement information 50” means that the user 16 performs some sort of operation on the advertisement information 50 displayed on the terminal 13. Examples of such an operation include an operation of the user 16 tapping a banner of the advertisement information 50 displayed on the terminal 13 and an operation of the user 16 clicking an URL or text displayed as the advertisement information 50. “URL” stands for uniform resource locator.

According to the present embodiment, the user 16 is guided to a point associated with an advertisement.

The control device 20 acquires the advertisement information 50 selected by the user 16 and refers to the acquired advertisement information 50 to calculate the second route. The control device 20 may acquire only the identifier included in the advertisement information 50 instead of acquiring the advertisement information 50 as it is. The control device 20 refers to the identifier included in the advertisement information 50. When the identifier is an identifier of a point, the control device 20 specifies the point as a point associated with the identifier. When the identifier is an identifier of a facility, the control device 20 specifies a point where the facility is located as a point associated with the identifier. When the identifier is an identifier of a product, the control device 20 specifies a point where the product is sold as a point associated with the identifier. The control device 20 calculates a route to the destination via the specified point as the second route, and determines the calculated second route as a route that is newly set in the device 14.

Before determining the calculated second route as a route that is newly set in the device 14, the control device 20 may calculate travel time required to reach the destination for the first route and travel time required to reach the destination for the second route and notify the user 16 of the calculated travel time for the first route and the calculated travel time for the second route. Alternatively, before determining the calculated second route as a route that is newly set in the device 14, the control device 20 may calculate travel cost required to reach the destination for the first route and travel cost required to reach the destination for the second route and notify the user 16 of the calculated travel cost for the first route and the calculated travel cost for the second route. The control device 20 may notify the user 16 of the difference in travel time between the first and second routes or the difference in travel cost between the first and second routes.

In the present embodiment, the advertisement information 50 is delivered from the control device 20 to the first device 30. The advertisement information 50 may be delivered from the second device 40, instead of from the control device 20, to the first device 30. Alternatively, the advertisement information 50 may be delivered from a server of an advertiser or advertising agency under contract with a taxi company that owns the vehicle 17 the user 16 is riding in, instead of from the control device 20, to the first device 30. Alternatively, the advertisement information 50 may be delivered from a third device that is used in at least one facility to the first device 30. Specifically, the advertisement information 50 may be delivered from a device or terminal that is used in a store located on or near the second route to the first device 30.

The advertisement information 50 is delivered to the first device 30 via a wireless LAN in the vehicle 17 the user 16 is riding in.

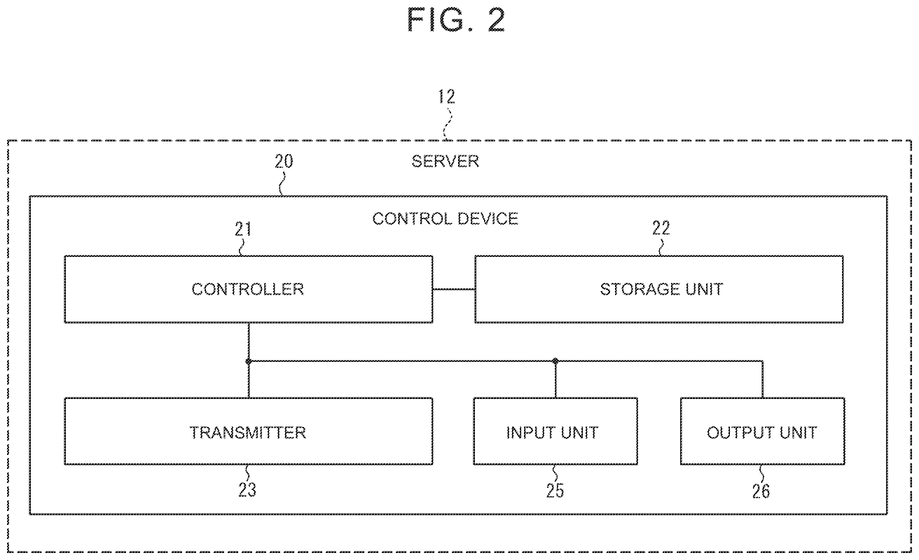

The configuration of the control device 20 according to the present embodiment will be described with reference to FIG. 2.

In the present embodiment, the control device 20 is configured as the server 12. That is, the control device 20 is included in the system 11 according to the present embodiment as the server 12. The server 12 is, for example, a server that belongs to a cloud computing system or other computing system.

The control device 20 includes a controller 21, a storage unit 22, a transmitter 23, an input unit 25, and an output unit 26.

The controller 21 includes one or more processors, one or more dedicated circuits, or a combination thereof. The processor is a general-purpose processor such as a CPU or a dedicated processor that specializes in specific processing. “CPU” stands for central processing unit. The dedicated circuit is, for example, an FPGA or an ASIC. “FPGA” stands for field-programmable gate array. “ASIC” stands for application specific integrated circuit. The controller 21 performs processing related to the operation of the control device 20 while controlling each unit of the control device 20.

The storage unit 22 includes one or more semiconductor memories, one or more magnetic memories, one or more optical memories, or a combination of at least two types of these memories. The semiconductor memory is, for example, a RAM or a ROM. “RAM” stands for random access memory. “ROM” stands for read only memory. The RAM is, for example, an SRAM or a DRAM. “SRAM” stands for static random access memory. “DRAM” stands for dynamic random access memory. The ROM is, for example, an EEPROM. “EEPROM” stands for electrically erasable programmable read only memory. The storage unit 22 functions as, for example, a main storage device, an auxiliary storage device, or a cache memory. The storage unit 22 stores data to be used for the operation of the control device 20 and data obtained by the operation of the control device 20.

The transmitter 23 includes one or more communication interfaces. The communication interface is, for example, a LAN interface. The transmitter 23 receives data to be used for the operation of the control device 20 and sends data obtained by the operation of the control device 20.

The input unit 25 includes one or more input interfaces. The input interface is, for example, a physical key, a capacitive key, a pointing device, a touch screen integrated with a display, or a microphone. The input unit 25 receives an operation of entering data to be used for the operation of the control device 20.

The output unit 26 includes one or more output interfaces. The output interface is, for example, a display or a speaker. The display is, for example, an LCD or an organic EL display. “LCD” stands for liquid crystal display. “EL” stands for electroluminescence. The output unit 26 outputs data obtained by the operation of the control device 20.

Functions of the control device 20 are implemented by executing a control program according to the present embodiment by the processor included in the controller 21. That is, the functions of the control device 20 are implemented by software. The control program is a program for causing a computer to perform steps included in the operation of the control device 20 such that the computer implements functions corresponding to the steps. That is, the control program is a program for causing the computer to function as the control device 20.

The program can be recorded on a computer-readable recording medium. The computer-readable recording medium is, for example, a magnetic recording device, an optical disc, a magnetooptical recording medium, or a semiconductor memory. The program is distributed by, for example, selling, transferring, or lending a portable recording medium, such as a DVD or a CD-ROM, having the program recorded thereon. “DVD” stands for digital versatile disc. “CD-ROM” stands for compact disc read only memory. The program may be stored in the storage of a server and be distributed by transferring the program from the server to other computers. The program may be provided as a program product.

For example, the computer first stores the program recorded on the portable recording medium or the program transferred from the server in a main storage device. The computer then reads the program stored in the main storage device by a processor and performs processing according to the read program by the processor. The computer may read the program directly from the portable recording medium and perform the processing according to the program. The computer may perform the processing according to the received program every time the program is transferred from the server to the computer. The program may not be transferred from the server to the computer and the computer may perform the processing using what is called an ASP service that allows the computer to implement functions by merely sending execution instructions and acquiring results. “ASP” stands for application service provider. The term “program” includes information that is equivalent to the program and that is provided for processing by an electronic computer. For example, data that is not direct commands for a computer but has properties that define processing of the computer falls under the “information equivalent to the program.”

A part or all of the functions of the control device 20 may be implemented by the dedicated circuit included in the controller 21. That is, a part or all of the functions of the control device 20 may be implemented by hardware.

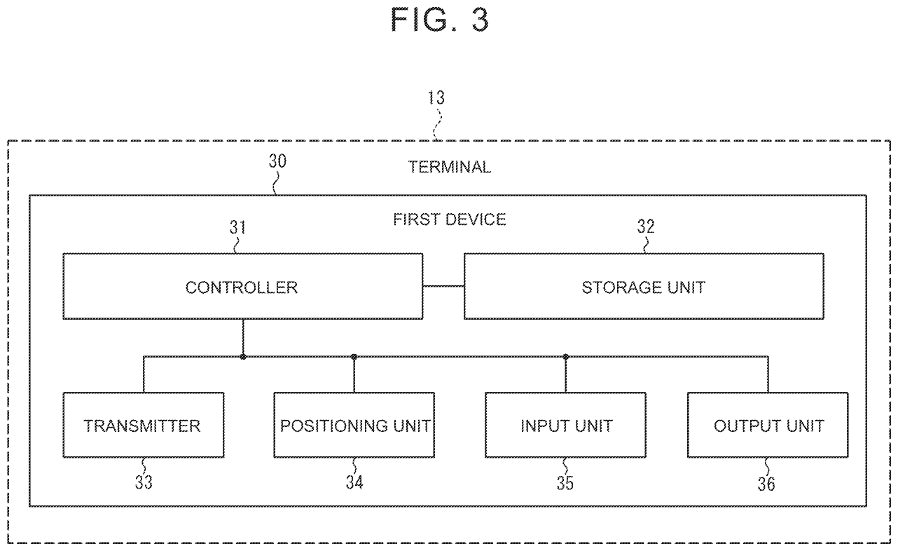

The configuration of the first device 30 according to the present embodiment will be described with reference to FIG. 3.

In the present embodiment, the first device 30 is configured as the terminal 13. That is, the first device 30 is included in the system 11 according to the present embodiment as the terminal 13. The first device 30 is, for example, a mobile phone, a smartphone, a tablet, or a PC. “PC” stands for personal computer.

The first device 30 includes a controller 31, a storage unit 32, a transmitter 33, a positioning unit 34, an input unit 35, and an output unit 36.

The controller 31 includes one or more processors, one or more dedicated circuits, or a combination thereof. The processor is a general-purpose processor such as a CPU or a dedicated processor that specializes in specific processing. The dedicated circuit is, for example, an FPGA or an ASIC. The controller 31 performs information processing related to the operation of the first device 30 while controlling each unit of the first device 30.

The storage unit 32 includes one or more semiconductor memories, one or more magnetic memories, one or more optical memories, or a combination of at least two types of these memories. The semiconductor memory is, for example, a RAM or a ROM. The RAM is, for example, an SRAM or a DRAM. The ROM is, for example, an EEPROM. The storage unit 32 functions as, for example, a main storage device, an auxiliary storage device, or a cache memory. The storage unit 32 stores information to be used for the operation of the first device 30 and information obtained by the operation of the first device 30.

The transmitter 33 includes one or more communication interfaces. The communication interface is, for example, an interface according to a mobile communication standard such as LTE, 4G, or 5G, a LAN interface, or an interface for short-range wireless communication such as Bluetooth (registered trademark). “LTE” stands for Long Term Evolution. “4G” stands for 4th generation. “5G” stands for 5th generation. The transmitter 33 receives information to be used for the operation of the first device 30 and sends information obtained by the operation of the first device 30.

The positioning unit 34 includes one or more GNSS receivers. “GNSS” stands for global navigation satellite system. The GNSS includes, for example, at least one of GPS, QZSS, GLONASS, and Galileo. “GPS” stands for Global Positioning System. “QZSS” stands for Quasi-Zenith Satellite System. QZSS satellites are called quasi-zenith satellites. “GLONASS” stands for Global Navigation Satellite System. The positioning unit 34 acquires location information of the first device 30 as location information of the user 16.

The input unit 35 includes one or more input interfaces. The input interface is, for example, a physical key, a capacitive key, a pointing device, a touch screen integrated with a display, a microphone, a camera, or an NFC tag. “NFC” stands for near-field communication. The input unit 35 receives an operation of entering data to be used for the operation of the first device 30.

The output unit 36 includes one or more output interfaces. The output interface is, for example, a display or a speaker. The display is, for example, an LCD or an organic EL display. The output unit 36 outputs data obtained by the operation of the first device 30.

Functions of the first device 30 are implemented by executing a communication program according to the present embodiment by the processor included in the controller 31. That is, the functions of the first device 30 are implemented by software. The communication program is a program for causing a computer to perform steps included in the operation of the first device 30 such that the computer implements functions corresponding to the steps. That is, the communication program is a program for causing the computer to function as the first device 30.

A part or all of the functions of the first device 30 may be implemented by the dedicated circuit included in the controller 31. That is, a part or all of the functions of the first device 30 may be implemented by hardware.

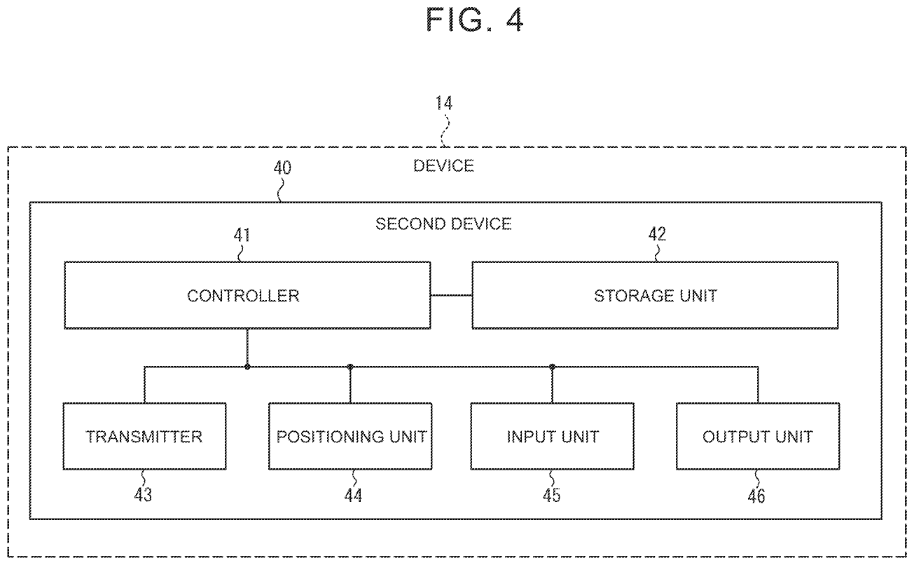

The configuration of the second device 40 according to the present embodiment will be described with reference to FIG. 4.

In the present embodiment, the second device 40 is configured as the device 14. The second device 40 is, for example, a mobile phone, a smartphone, a tablet, a PC, or a car navigation system.

The second device 40 includes a controller 41, a storage unit 42, a transmitter 43, a positioning unit 44, an input unit 45, and an output unit 46.

The controller 41 includes one or more processors, one or more dedicated circuits, or a combination thereof. The processor is a general-purpose processor such as a CPU or a dedicated processor that specializes in specific processing. The dedicated circuit is, for example, an FPGA or an ASIC. The controller 41 performs processing related to the operation of the second device 40 while controlling each unit of the second device 40.

The storage unit 42 includes one or more semiconductor memories, one or more magnetic memories, one or more optical memories, or a combination of at least two types of these memories. The semiconductor memory is, for example, a RAM or a ROM. The RAM is, for example, an SRAM or a DRAM. The ROM is, for example, an EEPROM. The storage unit 42 functions as, for example, a main storage device, an auxiliary storage device, or a cache memory. The storage unit 42 stores data to be used for the operation of the second device 40 and data obtained by the operation of the second device 40.

The transmitter 43 includes one or more communication interfaces. The communication interface is, for example, an interface according to a mobile communication standard such as LTE, 4G, or 5G or an interface for short-range wireless communication such as Bluetooth (registered trademark). The transmitter 43 receives data to be used for the operation of the second device 40 and sends data obtained by the operation of the second device 40.

The positioning unit 44 includes one or more GNSS receivers. The GNSS includes, for example, at least one of GPS, QZSS, GLONASS, and Galileo. The positioning unit 44 acquires location information of the vehicle 17.

The input unit 45 includes one or more input interfaces. The input interface is, for example, a physical key, a capacitive key, a pointing device, a touch screen integrated with a display, or a microphone. The input unit 45 receives an operation of entering data to be used for the operation of the second device 40.

The output unit 46 includes one or more output interfaces. The output interface is, for example, a display or a speaker. The display is, for example, an LCD or an organic EL display. The output unit 46 outputs data obtained by the operation of the second device 40.

Functions of the second device 40 are implemented by executing a device program according to the present embodiment by the processor included in the controller 41. That is, the functions of the second device 40 are implemented by software. The device program is a program for causing a computer to perform steps included in the operation of the second device 40 such that the computer implements functions corresponding to the steps. That is, the device program is a program for causing the computer to function as the second device 40.

A part or all of the functions of the second device 40 may be implemented by the dedicated circuit included in the controller 41. That is, a part or all of the functions of the second device 40 may be implemented by hardware.

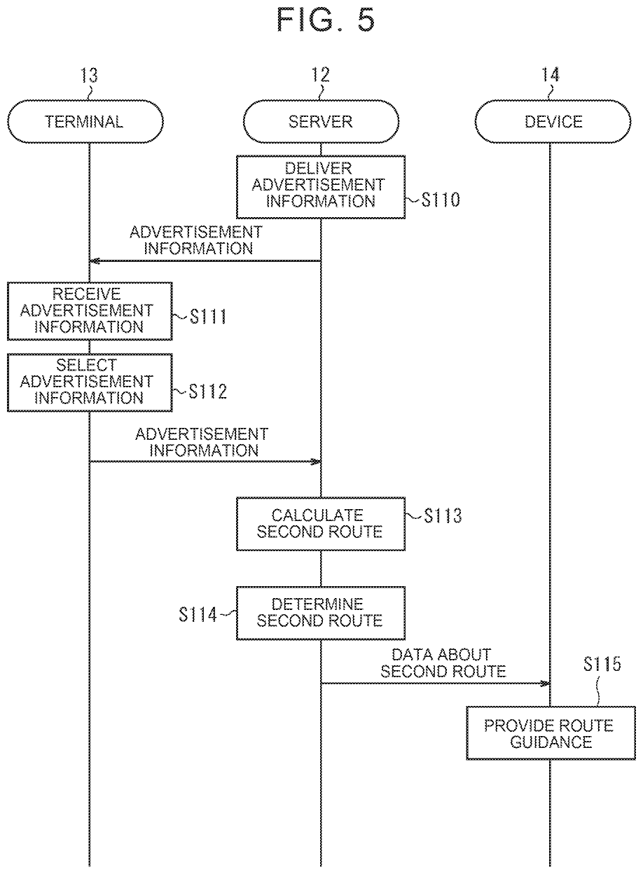

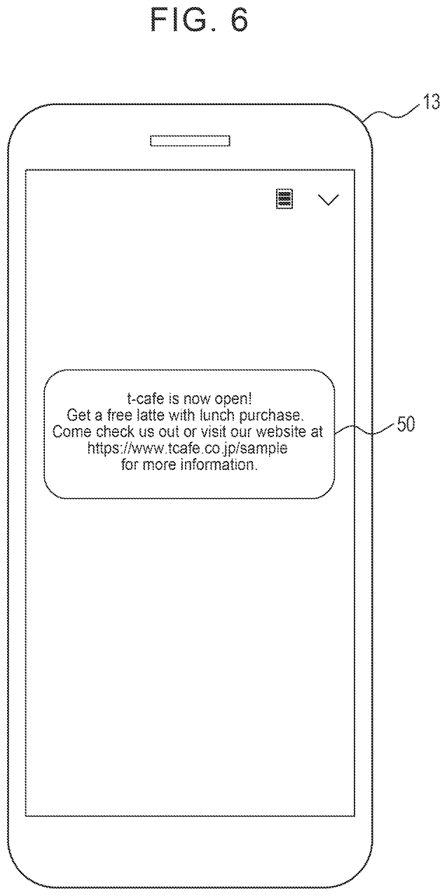

The operation of the system 11 according to the present embodiment will be described with reference to FIG. 5. This operation corresponds to a control method according to the present embodiment. FIG. 6 illustrates an example of a screen of the terminal 13.

For example, it is herein assumed that the advertisement information 50 has been delivered to the terminal 13 of the user 16 riding in a taxi that is the vehicle 17, and a first route to a destination has been set in the device 14 that is used for navigation in the taxi the user 16 is riding, which is the vehicle 17. In the present embodiment, the first route to the destination is set in the device 14 when the user 16 gets in the vehicle 17 or when the user 16 arranges the vehicle 17 for pickup.

In step S110, the controller 21 of the server 12 delivers the advertisement information 50 to the terminal 13. The controller 21 may communicate with the third device that is used in at least one facility via the transmitter 23, receive the advertisement information 50 from the third device, and deliver the received advertisement information 50 to the terminal 13.

In step S111, the user 16 receives the advertisement information 50 via the transmitter 33 of the terminal 13. Specifically, the controller 31 of the terminal 13 provides the delivered advertisement information 50 to the user 16. The advertisement information 50 is delivered as text, a still image, or a video and is displayed on the screen of the terminal 13.

In this example, the advertisement information 50 is, for example, the following text message including an URL as shown in FIG. 6, “t-cafe is now open! Get a free latte with lunch purchase. Come check us out or visit our website at https://www.tcafe.co.jp/sample for more information,” and is displayed as a banner on the screen of the terminal 13 as shown in FIG. 6.

In the present embodiment, the terminal 13 can connect to a wireless LAN in the vehicle 17 for free while the user 16 is riding in the vehicle 17. The advertisement information 50 is delivered only while the terminal 13 is connected to the wireless LAN in the vehicle 17. The advertisement information 50 may also be delivered while the terminal 13 is connected to a mobile network. In this case, however, the user 16 may not feel comfortable receiving the advertisement information 50 or using the vehicle 17 as the user 16 is charged for data usage. According to the present embodiment, the advertisement information 50 is delivered only while the terminal 13 is connected to the wireless LAN. The user 16 is therefore less likely to feel uncomfortable receiving the advertisement information 50 or using the vehicle 17.

In step S112, the user 16 selects the advertisement information 50. Specifically, the user 16 selects the displayed advertisement information 50 via the input unit 35 of the terminal 13. For example, the user 16 selects the advertisement information 50 by tapping the screen of the terminal 13. When the user 16 selects the advertisement information 50, the controller 31 of the terminal 13 receives the selection of the advertisement information 50 via the input unit 35. The controller 31 stores the selected advertisement information 50 in the storage unit 32 and sends the selected advertisement information 50 to the server 12 via the transmitter 33. The server 12 may only acquire the identifier included in the advertisement information 50, instead of acquiring the advertisement information 50 as it is. As described above, the identifier is, for example, an identifier of at least one point, at least one facility, or at least one product.

In step S113, the controller 21 of the server 12 calculates a second route based on the received advertisement information 50. The second route is a route to the same destination as that of the first route set in the device 14 that is used for navigation in the vehicle 17 but via a point associated with the advertisement information 50. Specifically, the controller 21 of the server 12 specifies, based on the identifier included in the advertisement information 50 sent in step S112, the point associated with the advertisement information 50 and calculates a route to the same destination as that of the first route but via the point as the second route. For example, in the case where the received advertisement information 50 includes an identifier of a product, a point where the product is sold is associated with the identifier. The controller 21 of the server 12 can therefore specify the point where the product is sold as the point associated with the advertisement information 50 by obtaining the identifier of the product from the advertisement information 50. For example, an identifier and a point may be associated in advance with each other and stored in advance in the storage unit 22 of the server 12, and the controller 21 may specify the point by referring to the storage unit 22.

In this example, the advertisement information 50 includes “t-cafe,” which is a name of a shop as a facility, as an identifier, and the storage unit 22 of the server 12 has stored therein a point associated in advance with the identifier. Accordingly, the controller 21 of the server 12 can specify a point where the facility corresponding to the identifier is located as a point associated with the advertisement information 50 by obtaining the identifier included in the advertisement information 50 and referring to the storage unit 22.

In step S114, the controller 21 of the server 12 determines the calculated second route as a route that is newly set in the device 14. Specifically, the controller 21 of the server 12 stores the second route calculated in step S113 in the storage unit 22 and sends data about the second route to the device 14 via the transmitter 23.

In step S115, the controller 41 of the device 14 receives via the transmitter 43 the data about the second route sent in step S114. The controller 41 stores the received data about the second route in the storage unit 42. The controller 41 performs control for providing route guidance for the second route to the driver of the vehicle 17 based on the data about the second route stored in the storage unit 42. According to this control, the output unit 46 of the device 14 displays on the screen the route guidance for the second route to the destination via the point associated with the advertisement information 50 selected by the user 16 and thus provides the route guidance for the second route to the driver of the vehicle 17.

In this example, the controller 41 of the device 14 displays the second route received from the server 12 on the screen of a car navigation application running on the device 14.

According to the present embodiment, the user can be guided to a point associated with an advertisement. Moreover, the user 16 riding in the vehicle 17 can change the route to the destination with improved convenience.

In a modification of the embodiment, before determining the second route as a route that is newly set in the device 14, the controller 21 of the server 12 may compare the first and second routes and provide to the user 16 the travel time or cost required to reach the destination for the first route and the travel time or cost required to reach the destination for the second route or at least one of the difference in travel time between the first and second routes and the difference in travel cost between the first and second routes. Specifically, after calculating the second route in step S113 and before determining the calculated second route as a route that is newly set in the device 14 in step S114, the controller 21 of the server 12 may notify the user 16 of the travel time or cost required to reach the destination for the first route and the travel time or cost required to reach the destination for the second route or may notify the user 16 of the difference in travel time between the first and second routes or the difference in travel cost between the first and second routes. For example, the controller 21 of the server 12 may send to the terminal 13 of the user 16 an instant message indicating the travel time or cost required to reach the destination for the first route and the travel time or cost required to reach the destination for the second route or at least one of the difference in travel time between the first and second routes and the difference in travel cost between the first and second routes and may display this instant message on the terminal 13 of the user 16.

According to this modification, the user 16 can compare the first and second routes and choose between the first and second routes. The user 16 can also choose not to change the route depending on the travel time or cost.

In a modification of the embodiment, when the vehicle 17 is traveling on the first route, the controller 21 of the server 12 may obtain information indicating the current location of the vehicle 17 and set the starting point of the second route to a point different from the starting point of the first route. Specifically, when the user 16 selects the advertisement information 50 in step S112, the selected advertisement information 50 is sent not only to the server 12 but also to the controller 41 of the device 14 via the transmitter 33 of the terminal 13. When the controller 41 receives the advertisement information 50 via the transmitter 43, the controller 41 acquires location information indicating the current location of the vehicle 17 via the positioning unit 44 and stores the acquired location information in the storage unit 42. The controller 41 sends the location information stored in the storage unit 42 to the server 12 via the transmitter 43. The controller 21 of the server 12 receives the location information from the controller 41 via the transmitter 23. The controller 21 then calculates as the second route a route from a point corresponding to the received location information to the same destination as that of the first route that has already been set in the device 14 via a point acquired based on the advertisement information 50 selected by the user 16. The controller 21 stores the calculated second route in the storage unit 42 and notifies the device 14 of the stored second route.

According to this modification, the route can be changed even while the vehicle 17 is traveling. Convenience is thus improved.

In a modification of the embodiment, the control device 20 may be configured as the terminal 13. In this case, the control device 20 also functions as the first device 30. Specifically, the controller 31, the storage unit 32, the transmitter 33, the input unit 35, and the output unit 36 of the first device 30 perform operations similar to those of the controller 21, the storage unit 22, the transmitter 23, the input unit 25, and the output unit 26 of the control device 20 in the embodiment. However, step S110 may be performed by the server 12. In step S112, the terminal 13 merely stores the advertisement information 50 selected by the user 16 in the storage unit 32 and does not send the selected advertisement information 50 to the server 12. In step S113, the controller 31 calculates the second route based on the advertisement information 50 stored in the storage unit 32. For example, an identifier and a point that are included in the advertisement information 50 may be associated in advance with each other and stored in advance in the storage unit 32 of the terminal 13, and the controller 31 may specify the point by referring to the storage unit 32.

In a modification of the embodiment, the control device 20 may be configured as the device 14. In this case, the control device 20 also functions as the second device 40. Specifically, the controller 41, the storage unit 42, the transmitter 43, the input unit 45, and the output unit 46 of the second device 40 perform operations similar to those of the controller 21, the storage unit 22, the transmitter 23, the input unit 25, and the output unit 26 of the control device 20 in the embodiment. However, step S110 may be performed by the server 12. Steps S111 and S112 are performed by the terminal 13. In step S112, the terminal 13 sends the advertisement information 50 selected by the user 16 not to the server 12 but to the device 14 via the transmitter 33. In step S113, the controller 41 of the device 14 calculates the second route based on the received advertisement information 50. In step S114, the controller 41 determines the calculated second route as a route that is newly set in the device 14. In step S115, the controller 41 stores data about the second route determined in step S114 in the storage unit 42.

In a modification of the embodiment, the terminal 13 and the vehicle 17 may individually calculate the second route. In this case, the second routes individually calculated by the terminal 13 and the vehicle 17 may not be the same.

In a modification of the embodiment, either the terminal 13 or the vehicle 17 may calculate the second route. In this case, the terminal 13 or the vehicle 17 that calculates the second route may share the calculated second route with the other that does not calculate the second route by notifying the other of the calculated second route.

The present disclosure is not limited to the above embodiment. For example, a plurality of blocks illustrated in each block diagram may be integrated, or one block may be divided into a plurality of blocks. Instead of performing the steps in the flowchart in the chronological order according to the description, the steps may be performed in parallel or in a different order either depending on the processing capability of the device that performs the steps or as necessary. Other modifications can be made without departing from the spirit and scope of the present disclosure.

What is claimed is:

1. A control device comprising a controller configured to determine, when advertisement information received via a first device is selected by a user riding in a vehicle, a second route via a point associated with the advertisement information as a route that is newly set in a second device, the second device being a device that is used for navigation in the vehicle, the second route being a route to a destination that is the same as a destination of a first route set in the second device.

2. The control device according to claim 1, wherein:
the advertisement information includes an identifier of at least one point; and
the controller is configured to specify a point corresponding to the identifier included in the advertisement information as the point associated with the advertisement information.

3. The control device according to claim 1, wherein:
the advertisement information includes an identifier of at least one facility; and
the controller is configured to specify a point where the facility corresponding to the identifier included in the advertisement information is located as the point associated with the advertisement information.

4. The control device according to claim 1, wherein:
the advertisement information includes an identifier of at least one product; and
the controller is configured to specify a point where the product corresponding to the identifier included in the advertisement information is sold as the point associated with the advertisement information.

5. The control device according to claim 1, wherein the controller is configured to notify, before determining the second route as the route that is newly set in the second device, the user of first travel time and second travel time, or a difference between the first travel time and the second travel time, the first travel time being required to reach the destination for the first route, the second travel time being required to reach the destination for the second route.

6. The control device according to claim 1, wherein the controller is configured to notify, before determining the second route as the route that is newly set in the second device, the user of first travel cost and second travel cost, or a difference between the first travel cost and the second travel cost, the first travel cost being required to reach the destination for the first route, the second travel cost being required to reach the destination for the second route.

7. The control device according to claim 1, wherein the control device is configured to also function as the first device.

8. The control device according to claim 1, the control device further comprising a transmitter configured to communicate with the first device, wherein the controller is configured to distribute the advertisement information to the first device via the transmitter.

9. The control device according to claim 8, wherein:
the transmitter is configured to communicate with a third device that is used in at least one facility; and
the controller is configured to
receive the advertisement information from the third device via the transmitter, and
distribute the received advertisement information to the first device.

10. The control device according to claim 1, wherein the control device is configured to also function as the second device.

11. The control device according to claim 1, the control device further comprising a transmitter configured to communicate with the second device, wherein the controller is configured to set the determined second route in the second device via the transmitter.

12. The control device according to claim 11, wherein:
the transmitter is configured to communicate with a third device that is used in at least one facility; and
the controller is configured to receive the advertisement information from the third device via the transmitter.

13. The control device according to claim 1, wherein the advertisement information is distributed to the first device via a wireless LAN in the vehicle.

14. A system comprising:
a control device including a controller configured to determine, when advertisement information received via a first device is selected by a user riding in a vehicle, a second route via a point associated with the advertisement information as a route that is newly set in a second device, the second device being a device that is used for navigation in the vehicle, and the second route being a route to a destination that is the same as a destination of a first route set in the second device; and
the first device.

15. The system according to claim 14, the system further comprising the second device.

16. A non-transitory storage medium storing instructions that are executable by one or more processors and that cause the one or more processors to perform functions comprising:
causing advertisement information received via a first device to be selected by a user riding in a vehicle; and
determining a second route via a point associated with the advertisement information as a route that is newly set in a second device, the second device being a device that is used for navigation in the vehicle, the second route being a route to a destination that is the same as a destination of a first route set in the second device.

17. The non-transitory storage medium according to claim 16, wherein the one or more processors are included in a control device and the first device.

18. The non-transitory storage medium according to claim 16, wherein the one or more processors are included in a control device and the second device.

19. The non-transitory storage medium according to claim 16, wherein the advertisement information is distributed to the first device via a wireless LAN in the vehicle.

20. A control method comprising:
causing advertisement information received via a first device to be selected by a user riding in a vehicle; and
determining a second route via a point associated with the advertisement information as a route that is newly set in a second device, the second device being a device that is used for navigation in the vehicle, and the second route being a route to a destination that is the same as a destination of a first route set in the second device.
